(19) United States
(12) Patent Application Publication
(10) Pub. No.: US 2023/0323194 A1
(43) Pub. Date: Oct. 12, 2023

(54) FOAM STABILIZATION USING NANOPARTICLES

(71) Applicant: SAUDI ARABIAN OIL COMPANY, Dhahran (SA)

(72) Inventors: Prasad Baburao Karadkar, Dhahran (SA); Bader G. Harbi, Dammam (SA); Mohammed Bataweel, Dhahran (SA)

(73) Assignee: SAUDI ARABIAN OIL COMPANY, Dhahran (SA)

(21) Appl. No.: 17/658,278

(22) Filed: Apr. 7, 2022

(51) Int. Cl. C09K 8/70; C09K 8/68; C09K 8/60

(52) U.S. Cl. CPC C09K 8/703; C09K 8/68; C09K 8/604; C09K 8/72

(57) ABSTRACT

A method of stimulating a hydrocarbon-bearing formation may include generating a foamed fracturing fluid with foam quality of at least 20% and introducing the foamed fracturing fluid into the formation under a pressure greater than the fracturing pressure of the formation. The foamed fracturing fluid may comprise a zwitterionic surfactant, a nanoparticle, and a gas phase. The surfactant may have a structure that includes a quaternary ammonium cation and a carboxylate group. Another method of stimulating a hydrocarbon-bearing formation may include introducing a foaming composition into the hydrocarbon-bearing formation under a pressure greater than the fracturing pressure of the formation and generating a foam with a quality of at least 20% by injecting a gas phase inside the formation. The foaming composition may include a surfactant, a nanoparticle, and a gas phase. The surfactant may have a quaternary ammonium cation and a carboxylate group in the structure.

### BACKGROUND

Well stimulation enables the improved extraction of hydrocarbon reserves that conventional recovery processes, such as gas or water displacement, cannot access. One well stimulation technique that is widely employed is hydraulic fracturing, which involves the injection of a fluid into a formation at a pressure that is greater than the fracture pressure. This increases the size and extent of existing fractures within the formation and may create new fractures.

Hydraulic fracturing is used in the oil and gas industry to stimulate production in hydrocarbon-containing formations. It is an oil field production technique that involves injecting a pressurized fluid to artificially fracture subsurface formations. The fracturing is created after drilling a well by injecting suitable fluids such as water or chemicals into the well under pressure to induce fractures in a formation. For example, pressurized hydraulic fracturing fluids may be pumped into a subsurface formation to be treated, causing fractures to open in the subsurface formation. The fractures may extend away from the wellbore according to the natural stresses within the formation.

Hydraulic fractures may be generated in the hydrocarbon reservoir by pumping fluid, often primarily water, from a hydraulic fracturing unit on the surface through the wellhead and the wellbore. When the pressure in the wellbore is sufficiently increased by the pumping of the hydraulic fracturing unit on the surface, hydraulic fractures may be created within the hydrocarbon reservoir. Proppants, such as grains of sand or ceramic beads, may be provided with the pressurized hydraulic fracturing fluid, which may lodge into the hydraulically created fractures to keep the fracture open when the treatment pressure is released. The proppant-supported fractures may provide high-conductivity flow channels with a large area of formation to enhance hydrocarbon extraction.

A variety of fluids has been developed to withstand the high pump rates, shear stresses, and high temperatures and pressures a fracturing fluid may be exposed to. In particular, hydraulic fracturing fluids may be aqueous-based gels, emulsions, or foams. In such hydraulic fracturing fluids, complex chemical mixtures having sufficient viscosity properties may be included to generate fracture geometry in the formation rock and transport solid proppants holding the fracture open. In this context, the viscosity of the hydraulic fracturing fluids may impact the fracture initiation, propagation, and resulting dimensions.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of stimulating a hydrocarbon-bearing formation. The method may include generating a foamed fracturing fluid having a foam quality of at least 20%. The foamed fracturing fluid may comprise a zwitterionic surfactant having a structure comprising a quaternary ammonium cation and a carboxylate group, a nanoparticle, and a gas phase. The method may then include introducing the foamed fracturing fluid into the hydrocarbon-bearing formation under a pressure greater than the fracturing pressure of the formation to generate fractures in the formation.

In another aspect, embodiments disclosed herein relate to an alternate method of stimulating a hydrocarbon-bearing formation. The method may include introducing a foaming composition into the hydrocarbon-bearing formation under a pressure greater than the fracturing pressure of the formation to generate fractures in the formation. The foaming composition may comprise a zwitterionic surfactant and a nanoparticle. The zwitterionic surfactant has a structure comprising a quaternary ammonium cation and a carboxylate group. The method may then include generating a foam from the foaming composition inside the hydrocarbon-bearing formation by injecting a gas phase. The foam may have a foam quality of at least 20%.

Other aspects and advantages of the claimed subject matter will be apparent from the following description and the appended claims.

### BRIEF DESCRIPTION OF DRAWINGS

FIG. 1 is a block flow diagram of a method for preparing a foamed fracturing fluid in accordance with one or more embodiments.

FIGS. 2A and 2B are block flow diagrams of methods for stimulating a wellbore using a foamed fracturing fluid in accordance with one or more embodiments.

FIG. 3 is a graphical representation of the viscosity profiles of Example 1.

FIG. 4 is a graphical representation of the viscosity profiles of Example 2.

FIG. 5 is a graphical representation of the viscosity profiles of Example 3.

FIG. 6 is a graphical representation of the viscosity profiles of Example 4.

### DETAILED DESCRIPTION

Embodiments in accordance with the present disclosure generally relate to a method of making foamed fracturing fluid formulations and methods of treating the hydrocarbon-bearing formation using these foamed fracturing fluids. These fracturing fluids may comprise surfactant and nanoparticle mixtures. The surfactants may exhibit viscoelastic behavior under formation conditions. The present disclosure generally relates to a method of generating a foamed fracturing fluid and a method for stimulating a hydrocarbon-bearing formation by introducing the foamed fracturing fluid into the hydrocarbon-bearing formation under a pressure greater than the fracturing pressure of the formation to generate fractures in the formation.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

In one or more embodiments, the foamed fracturing fluid composition may include a zwitterionic surfactant, a surface-modified silica nanoparticle, an inert gas, and a base fluid. In some embodiments, the foamed fracturing fluid may further include a proppant.

Methods according to one or more embodiments may involve injecting the foamed fracturing fluids into a hydrocarbon-bearing formation, such that the foamed fracturing fluids transport a proppant into fractures of the hydrocarbon-bearing formation. The foamed fracturing fluids may have a lower viscosity than conventional fracturing fluids. Conventional fracturing fluids that are based on aqueous solutions may increase in viscosity under downhole conditions making them difficult to recover, whereas the foamed fracturing fluids of the present disclosure may decrease in viscosity under downhole conditions. When a foamed fracturing fluid contacts a hydrocarbon in a reservoir, its viscosity may drastically decrease, enabling easy flow back of the fluid during production. The foamed fracturing fluids may demonstrate increased stability under high temperature and pressure conditions, making them highly suitable for use in downhole environments. As the foamed fracturing fluid used in the present disclosure contains a biodegradable surfactant and nanoscale solid particulates, it generally does not cause damage to the formation due to effective flow back and lack of residual deposition inside the formation.

### Definitions

The term “wellbore” refers to a hole drilled into the surface of the earth. Wellbores are usually drilled in order to penetrate a reservoir that contains hydrocarbons, and such hydrocarbons may be recovered by extraction through a wellbore. A wellbore is also known as a borehole and may be cased with cement and/or steel to increase formation stability.

The term “fracturing” refers to an oil and gas well development process. The process usually involves several steps including injecting water, sand, and other chemicals under high pressure into a hydrocarbon-bearing formation through a wellbore. This process is intended to create new fractures in the rock as well as increase the size, extent, and connectivity of existing fractures. Fracturing is also known as hydraulic fracturing and fracking. It is used commonly in low-permeability rocks like tight sandstone, shale, and some coal beds to increase oil and/or gas flow to a well from petroleum-bearing rock formations and to create improved permeability in underground geothermal reservoirs.

The term “fracturing fluid” means a chemical mixture that is used in fracturing operations to increase the quantity of hydrocarbons that can be extracted. In such fracturing fluids, complex chemical mixtures having sufficient viscosity properties may be included to generate fracture geometry in the formation rock and transport solid proppants holding the fracture open. In this context, the viscosity of the hydraulic fracturing fluids may impact the fracture initiation, propagation, and resulting dimensions. Fracturing fluids may also contain proppants such as sand (“frac sand”) or ceramic beads to hold open fractures created in the formation.

The term “foam” refers to an emulsion of a dispersed gas phase in a continuous liquid phase stabilized using a surfactant or a foaming agent. In the present disclosure, nitrogen gas (N₂) and carbon dioxide (CO₂) are commonly used as gas phases while water-based fluid is used as liquid phase.

The term “foam quality” is a ratio of gas volume to foam volume (gas+liquid) at a certain pressure and temperature.

The term “nanoparticle” is defined as a particle where at least one dimension of the particle (i.e., the length, width, or height) is less than one micron.

The term “thermal stability” means the ability of a fluid to maintain its chemical and physical characteristics, meaning its ability to resist chemical reactions or changes in the physical state under heat. For instance, a compound with greater stability has more resistance to decomposition at high temperatures.

### Foamed Fracturing Fluid Composition

One or more embodiments of the present disclosure relate to a foamed fracturing fluid composition. For fracturing applications, the thermal stability of a foam at a high temperature is one of the main challenges. Foam bubbles tend to collapse because of foam's lamellae thinning, liquid drainage, and inter-bubble gas diffusion. Foams can be stabilized by lowering the permeability of gas components through foam film. This can be achieved by increasing the quantity of adsorbed surfactant in the foam film by adding synergic agents or by reducing the contact area at the gas-liquid phase using nanoparticles in the foam composition. Nanoparticles, being solid and chemically robust, can stabilize foam under harsh conditions such as high temperature and salinity. Thus, the foamed fracturing fluids disclosed herein may contain a zwitterionic surfactant, a surface-modified silica nanoparticle, a gas, and a base fluid. The foamed fracturing fluids disclosed herein may be particularly useful because they may require significantly less water when compared to conventional fracturing fluids.

In one or more embodiments, the foamed fracturing fluid composition includes at least one zwitterion surfactant. The zwitterionic surfactant may be a surfactant having a structure comprising a quaternary ammonium cation and a carboxylate group. An exemplary structure is shown in Formula (I):

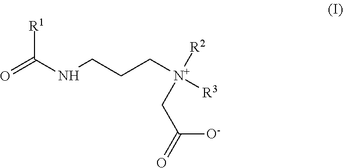

where R¹, R², and R³ are each, independently, a hydrogen, a hydrocarbon group, or a substituted hydrocarbon group.

As used throughout this description, the term “hydrocarbon group” may refer to branched, straight-chain, and ring-containing hydrocarbon groups, which may be saturated or unsaturated. The hydrocarbon groups may be primary, secondary, and/or tertiary hydrocarbons. The term “substituted hydrocarbon group” refers to a hydrocarbon group (as defined above) where at least one hydrogen atom is substituted with a non-hydrogen group that results in a stable compound. Such substituents may be groups selected from, but not limited to, halo, hydroxyl, alkoxy, oxo, alkanoyl, aryloxy, alkanoyloxy, amino, alkylamino, arylamino, arylalkylamino, disubstituted amines, alkanylamino, aroylamino, aralkanoylamino, substituted alkanoylamino, substituted arylamino, substituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide, substituted sulfonamide, nitro, cyano, carboxy, carbamyl, alkoxycarbonyl, aryl, substituted aryl, guanidine, and heterocyclyl, and mixtures thereof.

In one or more particular embodiments, the zwitterionic surfactant may be {[3-(Dodecanoylamino)propyl](dimethyl)ammonio}acetate, also referred to as cocoamidopropyl betaine (“CAPB”). The structure of such surfactant is represented by Formula (II):

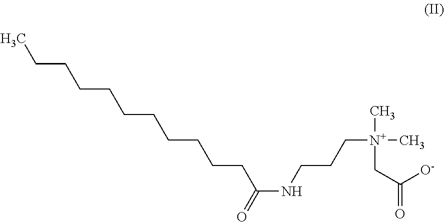 [SMILES: CCCCCCCCCCCC(=O)NCCC[N+](C)(C)CC(=O)[O-]]

In one or more embodiments, the zwitterionic surfactant composed fluid system may be thermally stable at a temperature of 250° F. or more, 300° F. or more, 350° F. or more, or 375° F. or more, as measured by foamed viscosity tests.

In one or more embodiments, the zwitterionic surfactant may be highly soluble in aqueous solutions, such as in deionized water, seawater, brines, calcium chloride solutions, and the like. In some embodiments, the zwitterionic surfactant may be soluble in aqueous solutions in an amount of 0.1% by weight or more, 1% by weight or more, and 10% by weight (wt. %) or more, 20 wt. % or more, at ambient temperature. In some embodiments, the solubility of the zwitterionic surfactant may increase with increasing temperature.

In one or more embodiments, the zwitterionic surfactant may be present in the foamed fracturing fluid composition in an amount of about 0.1% to 20% by volume based on the total volume of the liquid in the foamed fracturing fluid.] The amount of the zwitterionic surfactant may have a lower limit of any one of 0.1, 2, 5, 7, and 10% by volume based on the total volume of the foamed fracturing fluid, and an upper limit of any one of 10, 12, 15, 18 and 20% by volume based on the total volume of the foamed fracturing fluid, where any lower limit may be paired with any upper limit.

In one or more embodiments, the foamed fracturing fluid composition may include a metal oxide nanoparticle. Non-limiting examples of such metal oxide nanoparticles may include silica nanoparticles, aluminum oxide nanoparticles, and titanium dioxide nanoparticles. Both surface-modified or surface coated, and surface uncoated metal dioxide nanoparticles may be used for this application. In one or more particular embodiments, the foamed fracturing fluid composition may include a silica nanoparticle.

The metal oxide nanoparticle may be uncoated or it may include a surface coating.

In one or more embodiments, different functional groups may be used for coating the surface of nanoparticles for this application. Such functional groups may include but are not limited to silane, carboxylate, amine, amine, phosphonate, polyethylene glycol, octadecyl, carboxyl, and octadecyl. An example of such surface-modified silica nanoparticles may be silane-coated silica nanoparticles. Suitable silane-coated silica nanoparticles may be commercially available products, such as Bindzil® CC301 available from AkzoNobel. In one or more embodiments, silane-coated silica nanoparticles may be useful in keeping the nanoparticles suspended in a foamed fluid at a wide range of temperatures. In one or more embodiments, uncoated silica nanoparticles may also be used.

In one or more embodiments, the foamed fracturing fluid composition may include any conventionally used particle to stabilize foam composition that may be known to an ordinary person skilled in the art. Such particles may include clay nanoplatelets, polymer latexes, graphene oxides, and carbon nanotubes.

Nanoparticles may work as excellent stabilizers for gas-liquid foams such as the foams described herein. Due to their high surface energy, nanoparticles may have surface-active properties making them suitable for bridging two non-interacting chemicals. For foams, such stabilizing nanoparticles may act as a bridge between dispersed gas bubbles in a continuous liquid phase and form a solid barrier at the interface between the gas bubbles and the continuous liquid phase. The inclusion of nanoparticles in the disclosed foams, therefore, improves the stability of gas bubbles in a liquid phase and results in a stable foamed fluid.

As noted above, nanoparticles may be surface modified to improve their properties as foam stabilizing agents. Suitable surface modifying chemical materials for silica nanoparticles may include functional groups such as silane, carboxylate, amine, phosphonate, polyethylene glycol, octadecyl, carboxylate, and octadecyl. This surface modification may improve the contact of hydrophobic silica nanoparticles with the aqueous environment thereby improving their functionality as a foam stabilizer. Such surface-modified silica nanoparticles may be stable under room temperature and pressure conditions as well as increased temperature and pressure such that the nanoparticles may withstand local conditions in a reservoir.

The foamed fracturing fluids of one or more embodiments may comprise the silica nanoparticles in an amount of the range of about 0.1 to 20% by weight per total volume of the liquid in the foamed fracturing fluid (wt/vol). For example, the foamed fracturing fluid may contain the surface-modified silica nanoparticles in an amount ranging from a lower limit of any of 0.1, 0.5, 1, 5, 10, 15, 20, 25, and 30 wt/vol to an upper limit of any of 1, 5, 10, 15, 20, 25, 30, 35 and 40% wt/vol, where any lower limit can be used in combination with any mathematically-compatible upper limit.

In one or more embodiments, the foam stabilizing silica nanoparticles may be present in the foamed fracturing fluid composition in an amount of about 0.1% wt/vol to 20% wt/vol.

The silica nanoparticle may have any suitable particle size for stabilizing foams. For example, in one or more embodiments, the silica nanoparticles may have an average particle size ranging from about 1.0 nm to 500 nm. For example, the average particle size of the silica nanoparticle may have a lower limit of any one of 1.0, 5.0, 10, 20, 30, 50, 75, 100, 150, and 200, and an upper limit of any one of 250, 275, 300, 350, 400, 450 and 500, where any lower limit may be paired with any mathematically compatible upper limit. As will be appreciated by those skilled in the art, the nanoparticles as provided may have a distribution of particle sizes, which may be monodisperse or polydisperse.

In one or more embodiments, the surface-modified silica nanoparticles may be basic in nature and may include nanoparticles formed from a suitable silica source, for example, sodium silicate. The silica nanoparticles of the present disclosure may be provided in the form of a dispersion that includes excess sodium silicate. Thus, the composition may include sodium silicate as well as silica nanoparticles in the basic solution. The silica nanoparticle dispersions may have a pH between 7 and 12. In one or more embodiments, the silica nanoparticle dispersions may have a pH between 7 and 12, or a pH between 7 and 12, when measured at room temperature.

The foamed fracturing fluids of one or more embodiments may include a base fluid. In one or more embodiments, the base fluid may be a water-based fracturing fluid. The fracturing fluids may be an acid stimulation fluid or an enhanced oil recovery (EOR) fluid, among others.

In one or more embodiments, the water-based fracturing fluid may comprise an aqueous fluid. The aqueous fluid may include at least one of freshwater, seawater, brine, water-soluble organic compounds, and mixtures thereof. Freshwater sources including rainwater, river water, and pond water may be used in the aqueous fluid composition. In one or more embodiments, process water including produced water at high salinity and high hardness values may be utilized for water-based fracturing fluid formulation. When using a freshwater source, the aqueous fluid may contain freshwater formulated to contain various salts. The salts may include but are not limited to, alkali metal halides and hydroxides. In one or more embodiments, the aqueous fluid may be a brine that may be any of seawater, aqueous solutions wherein the salt concentration is less than that of seawater, or aqueous solutions wherein the salt concentration is greater than that of seawater. Salts that are found in seawater may include sodium, calcium, aluminum, magnesium, potassium, strontium, and lithium salts of halides, carbonates, chlorates, bromates, nitrates, oxides, phosphates, among others. Any of the aforementioned salts may be included in brine. In one or more embodiments, the density of the aqueous fluid may be controlled by increasing the salt concentration in the brine, though the maximum concentration is determined by the solubility of the salt.

In one or more embodiments, the fracturing fluid may include at least one polymer selected from the group consisting of guar, derivatized guar, polyacrylamide, and combinations thereof. Other examples of polymers suitable for use in the disclosed composition may include polymers having carboxylate groups such as sulfonated polyacrylamide, high- or low-molecular-weight (MW) hydrolyzed polyacrylamides (HPAM), polyacrylates, polyethyleneimine, copolymers, terpolymers, crosslinked 2-Acrylamido-2-methylpropane sulfonic acid (AMPS), N-Vinylpyrrolidone (NVP), acrylamide/acrylate copolymers and terpolymers, amphoteric polymers and terpolymers, and hydrophobically modified poly[2-(dimethylamino)ethyl methacrylate] (pDMAEMA).

In one or more embodiments, the fracturing fluids may also include one or more acids. Acids may be included when the fracturing fluid is to be used in a matrix stimulation process, as described below. The acid may be any suitable acid known to a person of ordinary skill in the art, and its selection may be determined by the intended application of the fluid. In some embodiments, the acid may be one or more selected from the group consisting of hydrochloric acid, sulfuric acid, carboxylic acids such as acetic acid, and hydrofluoric acid. In some embodiments, hydrofluoric acid may be included as a hydrogen fluoride source, such as ammonium fluoride, ammonium bifluoride, fluoroboric acid, hexafluorophosphoric acid, and the like.

The foamed fracturing fluid of one or more embodiments may comprise one or more acids in a total amount of the range of about 1 to 23 wt. % hydrochloric acid.

The foamed fracturing fluids of one or more embodiments may include one or more additives. The additives may be any conventionally known and one of ordinary skill in the art will, with the benefit of this disclosure, appreciate that the selection of said additives will be dependent upon the intended application of the fracturing fluid. In some embodiments, the additives may be one or more selected from clay stabilizers, scale inhibitors, corrosion inhibitors, biocides, friction reducers, thickeners, fluid loss additives, and the like. In one or more embodiments, the carrier fluid may contain additives conventionally used in various oil and gas operations such as wellbore drilling, oil and gas extraction, and acid treatment. Such additives may include, but are not limited to, corrosion inhibitors, friction reducers, non-emulsification agents, anti-sludging agents, pH-adjusting agents, pH-buffers, oxidizing agents, enzymes, lost circulation materials, scale inhibitors, surfactants, clay stabilizers, paraffin inhibitors, asphaltene inhibitors, penetrating agents, clay control additives, reducers, oxygen scavengers, emulsifiers, foamers, gases, derivatives thereof, thickeners, viscosity modifiers, lubricants, shale inhibitors, weighting agents, deflocculants, a hydrogen sulfide, scavenger, iron control agent, mutual solvent, and combinations thereof.

The foamed fracturing fluid of one or more embodiments may comprise one or more additives in a total amount of the range of about 0.1 to 10 wt. %. For example, the foamed fracturing fluid may additives in a total amount from a lower limit of any of 0.1, 0.5, 1, 2, 3, 4, 5, 6, 7, 8, and 9 to an upper limit of any of 1, 2, 3, 4, 5, 6, 7, 8, 9 and 10, where any lower limit can be used in combination with any mathematically-compatible upper limit.

As noted above, foamed fracturing fluids described herein include a gas. The foamed fracturing fluid composition may be prepared by flowing gas into a liquid solution. The liquid solution includes the components as described above. The inert gas may be nitrogen gas (N₂), carbon dioxide gas (CO₂), argon gas, helium, and natural gas. In some instances, air may be used for generating foams in a fracturing fluid composition.

The gas flow rate, time of flowing gas, and amount of gas needed to generate foam in a fluid may depend on the environment such as temperature and pressure, fluid properties including but not limited to the fluid density, viscosity, and present solid particles. Nitrogen gas may be particularly suitable for generating foam due to its chemical inertness and relative abundance.

The volume of a foamed fluid vs the volume of the fluid prior to generating the foam may determine the effectiveness of gas in forming a foam. If insufficient gas is included in a fracturing fluid formulation, the gas bubbles in the fluid may be spherical and may not be in contact with each other. In such instances, the viscosity of the foamed fluid may be low as gas bubbles in a foamed fluid are responsible for creating a resistance in the free fluid flow. If enough gas is included in a fracturing fluid formulation, the volume of gas bubbles present in the foamed fracturing fluid may be large, and therefore, the foam quality may be considered high. In such foamed fracturing fluids, the gas bubbles may be in contact with each other and therefore, lose spherical shapes. This enhanced resistivity in fluid flow may cause the viscosity of the foamed fluid to increase.

In one or more embodiments, the foamed fracturing fluid may comprise the fracturing fluid solution and the gas of 10 to 80% by volume, where the volume ratio is given as the volume of the gas-free liquid fracturing fluid solution to the volume of the gas occupied in a foamed fracturing fluid. For example, the foamed fracturing fluid may contain the liquid fracturing fluid and the gas in a volume ratio ranging from a lower limit of any of 10, 15, 20, 25, 30, 35, 40, 45, 50, 55, 60, 65, 70, 75, 80, 85 and 90% to an upper limit of any of 20, 25, 30, 35, 40, 45, 50, 55, 60, 65, 70, 75, 80, 85, 90, 95 and 100%, where any lower limit can be used in combination with any mathematically-compatible upper limit.

The foamed fracturing fluids may be used alone to fracture the formation. Alternatively, they may be used with a sufficient quantity of a proppant. In one or more embodiments, 0.25 to 10 pounds (lbs) of proppant may be used in a gallon (gal) of foamed fracturing fluid composition. Such proppants may include gravel, sand, bauxite, or glass beads. Proppants may be uncoated or coated with resins such as epoxy, furan, novolak, polyepoxide resins, furan/furfuryl alcohol resins, phenoloic resins, urea-aldehyde resins, urethane resins, phenolic/latex resins, phenol-formaldehyde resins, polyester resins and acrylate resins, and copolymers and mixtures thereof. The particle size of the proppants may be from about 2 to about 400 mesh U.S. Sieve Series.

### Properties of the Foamed Fluid

In one or more embodiments, the foamed fracturing fluid may have a density in the range of 0.2 to 1.2 grams per cubic centimeters (g/cm³). For example, the foamed fracturing fluid may have a density ranging from a lower limit of any of 0.2, 0.3, 0.4, 0.5, 0.6, 0.7, 0.8, 0.9, and 1.0 g/cm³ an upper limit of any of 0.4, 0.5, 0.6, 0.7, 0.8, 0.9, 1.0, 1.1, and 1.2 g/cm³ where any lower limit can be used in combination with any mathematically-compatible upper limit.

Foam quality under certain pressure and temperatures is determined by measuring the ratio between gas volume and the total foam volume including gas and liquid phases. It is an important factor in determining foam stability and viscosity. Foam quality (Γ) as defined above is the ratio of gas volume to gas/liquid volume over a given temperature and pressure, and may be determined using Equation (I) below:

$$Γ = \frac{100 {V}_{g}}{{V}_{g} + {V}_{l}} \qquad ( I )$$

where V_{g} is the gas volume and V₁ is the liquid volume.

In foams that have a foam quality below about 50%, gas bubbles do not generally come in contact with each other. These foams have low foam viscosity and include a large volume of free liquid. Foam qualities ranging from 50% to 90% indicate a foam in which gas bubbles are in contact with each other, resulting in an increased foam viscosity. In one or more embodiments, foams of the present disclosure may have a foam quality ranging from 50% to 90%. For example, the foam quality of disclosed foams may have a value range having a lower limit of one of 50, 52, 55, 58, 60, 62, and 65% and an upper limit of one of 67, 70, 72, 75, 80, and 90%, where any lower limit may be paired with any mathematically compatible upper limit.

In one or more embodiments, foamed fracturing fluids having a foam quality below about 50%, may be used as an energized fluid. As used herein, “energized fluids” are defined as fluids with one or more compressible gas components, such as CO₂, N₂, or any combination of gases, dispersed in a small volume of liquid.

Foam viscosity is another key parameter in determining the effectiveness for use in the methods disclosed herein. Foam viscosity may be determined as follows. A mixture of liquid and gas is circulated through a helically coiled loop in a foam rheometer and the differential pressure across the coil is used to measure foam viscosity. Foam viscosity may be measured at different shear rates, as will be indicated for specific viscosity measurements.

In one or more embodiments, the foamed fracturing fluid may have a viscosity at 300° F. of at least about 20 cP (centipoise) at a shear rate of 100 1/s. Unless indicated otherwise, all viscosity values are obtained by using a circulating-loop foam rheometer at a shear rate of 100 1/s. For example, the fracturing fluid may have a viscosity at 300° F. at a shear rate of 100 1/s, ranging from a lower limit of any of 20, 25, 20, 35, 40, 45, 50 cP to an upper limit of any of 500, 600, 700, 800, 900, and 1000 cP, where any lower limit can be used in combination with any mathematically-compatible upper limit. In some embodiments, the fracturing fluids may have a viscosity at 300° F. at a shear rate of 100 s⁻¹, of 200 cP or more, 300 cP or more, 400 cP or more, 500 cP or more, 600 cP or more, 700 cP or more, 800 cP or more, or 900 cP or more, or 1000 cP or more.

In one or more embodiments, a foamed fracturing fluid composition excluding polymers and including silica nanoparticles may show improved rheological behavior under elevated temperatures. For example, a foamed fracturing fluid composition including a zwitterionic surfactant in water and nitrogen gas with a 76% foam quality may have a viscosity at 100 1/s that decreases by approximately 75% when the temperature increases from 300° F. to 350° F. This decrease in viscosity may occur due to thermal degradation in the absence of silica nanoparticles. In contrast, a foamed fracturing fluid composition including a zwitterionic surfactant in water, silica nanoparticles, and nitrogen gas with a similar foam quality may have a viscosity at 100 1/s that decreases by approximately 32% when the temperature increases from 300° F. to 350° F. Thus, the presence of nanoparticles in the foamed fracturing fluid decreases the thermal degradation of the foam at elevated temperatures as evidenced by the better-maintained viscosity.

In one or more embodiments, a foamed fracturing fluid composition including both polymers and silica nanoparticles may show improved rheological behavior under elevated temperatures. For example, a foamed fracturing fluid composition including a zwitterionic surfactant in water, polymers, and nitrogen gas may exhibit approximately 86% decrease in viscosity under increased temperature from 300° F. to 350° F. at 100 1/s shear rate due to thermal degradation. Again, a foamed fracturing fluid composition including a zwitterionic surfactant in water, silica nanoparticles, polymers, and nitrogen gas may exhibit an approximately 44% decrease in viscosity under increased temperature from 300° F. to 350° F. at 100 1/s shear rate due to thermal degradation. In both cases, silica nanoparticles improved the viscosity of the foamed fracturing fluids.

### Preparation of Foamed Fracturing Fluids

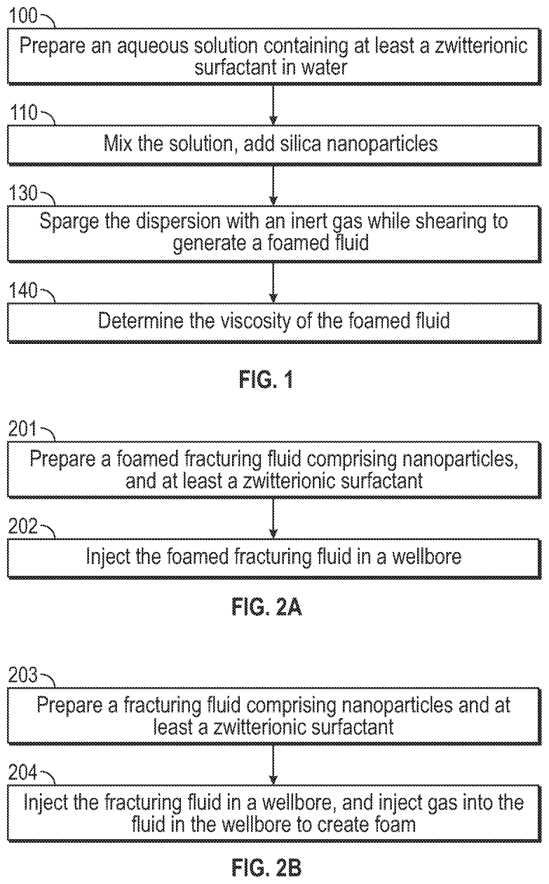

A method of preparing a foamed fracturing fluid of one or more embodiments is depicted by FIG. 1. All components and quantities discussed in relation to said method correspond to those discussed previously. In one or more embodiments, an aqueous solution containing a zwitterionic is prepared in step 100. The aqueous solution may be made by any suitable mixing method known in the art with amounts as described previously. Next, silica nanoparticles may be added in step 110 and the solution mixed to form a dispersion of silica nanoparticles in the aqueous surfactant solution. Then, the dispersion is sparged with an inert gas while shear mixing generates a foamed fluid in step 130. A foamed fluid may be generated by passing gas into the mixture while shearing the mixture under a certain shear rate. As gas bubbles form inside the fluid mixture, the zwitterionic surfactant helps generate foam, and the nanoparticles provide stability to the foams under a range of temperature and pressure. Finally, the viscosity may optionally be determined in step 140.

The foamed fracturing fluids may also be prepared by first making an aqueous zwitterionic surfactant solution, then generating a zwitterionic surfactant foam by passing gas in the surfactant solution at a certain shear rate, and then adding silica nanoparticles to the foamed surfactant solution. Continuous shearing at a certain rate may ensure well distribution of nanoparticles in the foamed mixture.

Furthermore, the foamed fracturing fluids may also be prepared by adding a zwitterionic surfactant solution to a mixture of silica nanoparticles while being sheared at a certain rate and passing gas into the mixture simultaneously. Thus, the components of the fracturing fluid may be added in any order. Standard mixing techniques may be used.

### Method of Fracturing or Stimulating a Well Using Foamed Fracturing Fluids

A method of stimulating a wellbore using a foamed fracturing fluid of one or more embodiments is depicted in FIGS. 2A and 2B. A foamed fracturing fluid may be prepared prior to injecting into a wellbore in step 201 as described above. Then, the foamed fracturing fluid may be injected into the wellbore in step 202. In one or more embodiments, a liquid fracturing fluid formulation may be prepared by mixing methods known in the art in step 203. The liquid formulation may contain all components of the fracturing foam except for the gas. Then the liquid formulation may be injected into the wellbore followed by the injection of the gaseous phase into the wellbore in step 204. In such embodiments, the foam may be generated in-situ in the wellbore by injecting an inert gas into the fluid.

A formation may be fractured by using the foamed fracturing fluids according to one or more embodiments. The foamed fracturing fluid may be injected into the wellbore at a pressure that may overcome the native overburden pressure of the formation, thus resulting in fracturing. The well may first be treated with a salt solution to help stabilize the formation prior to injection of the foamed fracturing fluids.

Methods in accordance with the present disclosure may include the injection of a foamed fracturing fluid into a formation. In one or more embodiments, the foamed fracturing fluid may be a single treatment fluid that is injected into the wellbore in one pumping stage. In other embodiments, methods in accordance with one or more embodiments may involve the injection of the foamed fracturing fluid and one or more additional stimulation fluids. The additional stimulation fluids may, in some embodiments, be co-injected with the foamed fracturing fluid. In some embodiments, the stimulation fluids may be injected after the foamed fracturing fluid.

The methods of one or more embodiments of the present disclosure may further comprise a pre-flushing step before the injection of the foamed fracturing fluid. The pre-flushing step may comprise flushing the formation with a flushing solution that comprises one or more surfactants. The flushing solution may be an aqueous solution, and the surfactant may be the same zwitterionic surfactants as included in the foamed fracturing fluid. The pre-flushing may limit the adsorption of the surfactants on the rock surface of the formation during the injection process. The suitability of the use of a pre-flushing step may depend on the type of surfactant and rock.

The hydrocarbon-containing formation of one or more embodiments may be a formation containing multiple zones of varying permeability. For instance, the formation may contain at least a zone having a relatively higher permeability and a zone having a relatively lower permeability. During conventional injection, fluids preferentially sweep the higher permeability zone, leaving the lower permeability zone incompletely swept. In one or more embodiments, the increased viscosity of the foamed fracturing fluid may “plug” the higher permeability zone, allowing subsequent fluid to sweep the low permeability zone and improving sweep efficiency.

The methods of one or more embodiments may be used for well stimulation. A well stimulation process in accordance with one or more embodiments of the present disclosure may include the step of injecting the foamed fracturing fluid into a hydrocarbon-bearing formation at an injection well. In some embodiments, the injection of the foamed fracturing fluid may be performed at a pressure that is below the fracturing pressure of the formation. A zone within the formation may be at a high temperature and increase the viscosity of the foamed fracturing fluid. After the increase in viscosity, the tail-end of the fluid is diverted to lower-permeability zones of the formation, displacing hydrocarbons. This results from the increase in viscosity that may “plug” the more permeable zones of the formation. The formation may be stimulated by the foamed fracturing fluid, creating pathways for hydrocarbon production. According to some embodiments, the displaced hydrocarbons may be recovered through the stimulated reservoir. In one or more embodiments, the hydrocarbons may be recovered at a production well.

The well stimulation process of one or more embodiments may be a matrix stimulation process. In the matrix stimulation process of one or more embodiments, the foamed fracturing fluid, or one of the stimulation fluids, may or may not contain an acid. The acid fluid may react with the formation, dissolving rock, and creating wormholes that create a pathway for hydrocarbons to be displaced from deeper within the rock. In one or more embodiments, the foamed fracturing fluid may have a high viscosity in the formation, enabling the fluid to better penetrate lower-permeability zones of the formation and allowing the acid to more uniformly react with the entire formation, and eventually drop in viscosity. This may provide for the formation of deeper wormholes and enhance the overall permeability of the near-wellbore region. In the absence of this initial high viscosity, the fluid will primarily penetrate the high permeability zones.

In one or more embodiments, the well stimulation process may be repeated one or more times to increase the amount of hydrocarbons recovered. In some embodiments, subsequent well stimulation processes may involve the use of different amounts of the surfactant and/or different surfactants than the first. The methods of one or more embodiments may advantageously provide improved sweep efficiency.

Embodiments disclosed herein may be useful when applied to unconventional reservoirs. Unconventional reservoirs may be defined as those formations wherein hydrocarbon recovery is not economically possible without the implementation of specialized stimulation treatments such as matrix acidizing or fracturing. Unconventional reservoirs such as shale gas, tight sands, heavy oil, and tar sands are some examples of formations that need specialized stimulation for hydrocarbon production.

Although the embodiments disclosed herein focus on accessing unconventional reservoirs, the following embodiments and disclosure can be applied to any formations that would be receptive to the methods and systems disclosed.

In one or more embodiments, local conditions of the reservoir may include elevated temperature, elevated pressure, acidic conditions, high salinity, and combinations thereof. As environmental conditions vary from the reservoir to reservoir, the foamed fracturing fluid particles may have suitable stability to withstand external stimuli in the reservoir. In such embodiments, the foam may be stable under the elevated temperature conditions in a range from 50° F. to 350° F., elevated salinity up to 200,000 ppm total dissolved solids, and a pH range from about 4 to 8. In addition, the foamed fracturing fluid may be stable in a time frame of several hours.

Embodiments disclosed herein may be useful over a wide range of downhole conditions, including temperatures of up to about 350° F., such as up to about 325° F., up to about 300° F., up to about 250° F., or up to about 200° F. In one or more embodiments, the formation may have a temperature ranging from about 50 to 350° F. For example, the formation may have a temperature that is of an amount ranging from a lower limit of any of 50, 60, 70, 80, 90, 100, 150, 200, 250, and 300° F. to an upper limit of any of 100, 150, 200, 250, 300, and 350° F., where any lower limit can be used in combination with any mathematically-compatible upper limit.

Downhole pressures may be from about 50 pounds per square inch (psi) (0.345 megapascals (MPa)) to about 30,000 psi (206 MPa), such as from about 100 psi (0.689 MPa) to about 30,000 psi, from about 1,000 psi (6.90 MPa) to about 30,000 psi, from about 50 psi to about 20,000 psi (138 MPa), from about 100 psi to about 20,000 psi (68.9 MPa), from about 1,000 psi to about 20,000 psi, from about 50 psi to about 10,000 psi, from about 100 psi to about 20,000 psi, or from about 1,000 psi to about 10,000 psi.

A person of ordinary skill in the art will appreciate, with the benefit of this disclosure, that the physical properties of a wellbore treatment fluid are important in determining the suitability of the fluid for a given application.

The following examples are merely illustrative and should not be interpreted as limiting the scope of the present disclosure.

### EXAMPLES

### Materials

A foaming agent, cocamidopropyl betaine, having the commercial name Marfoam® CAB, was supplied by Solvay. Silica nanoparticles having the commercial name BINDZIL® CC301 were supplied by AkzoNobel. Bindzil CC301 has 30% silane-modified colloidal silica, the average particle size is 7 nm. A fracturing fluid acrylamide-based polymer, having the commercial name FLOPAAM DP/EM 5015, was supplied by SNF Inc. FLOPAAM DP/EM 5015 has a 30% wt/vol acrylamide-based polymer. Nitrogen gas was used for generating foam in the surfactant-nanoparticles mixture.

### Foam Rheology Testing

A circulating-loop foam rheometer having a helically coiled, 0.25 inches diameter and 10 ft long tube was utilized to test the rheological behavior of fluids. The model of the used rheometer is CP353-8500, manufactured by Chandler Engineering, AZ, USA. For each sample, a foam was generated using N₂ gas by shearing the mixture inside the loop at 300 1/s. Once a 75% foam quality was achieved, the shear rate was dropped to 100 1/s. All tests were started at 300° F., after viscosity stabilization, the bath temperature was increased to 350° F. Pressure drop across a helical coil was utilized to calculate the viscosity of the foam using the Power-law model.

### Example 1

A surfactant solution was prepared by mixing a 1% (vol/vol) of the Marfoam® CAB in water. The solution was placed into the circulating-loop foam rheometer. The viscosity of the foam was tested according to the method provided above.

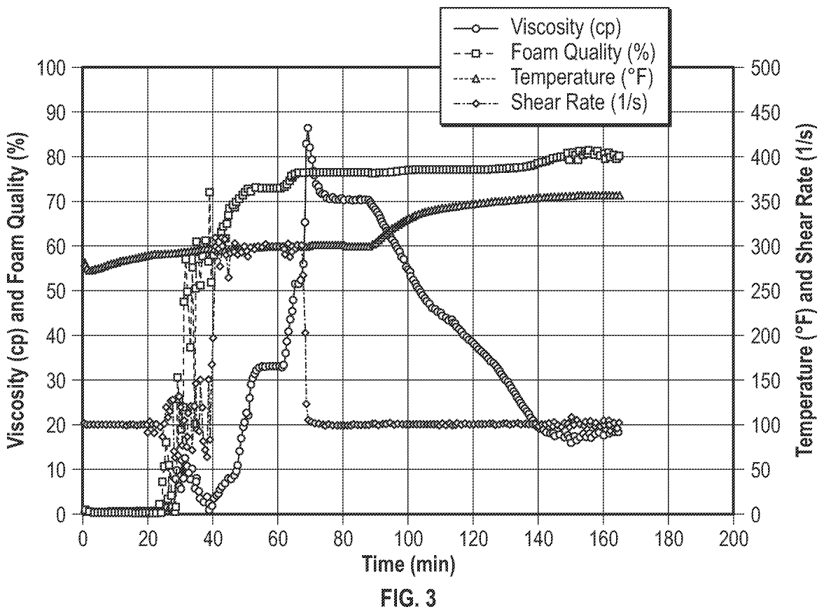

FIG. 3 shows the viscosity behavior of Example 1. A 76% foam quality was achieved using N₂ while shearing fluid at 300 1/s and 300° F. After foam stabilization, the shear rate was dropped to 100 1/s and kept constant throughout the test. The stabilized viscosity of the generated foam was measured to be 71 cp at 100 1/s. As a result of increasing the temperature to 350° F., the viscosity decreased significantly from 71 cp to 18 cp under the same conditions, except for the temperature. Therefore, approximately a 75% decrease in viscosity was observed.

### Example 2

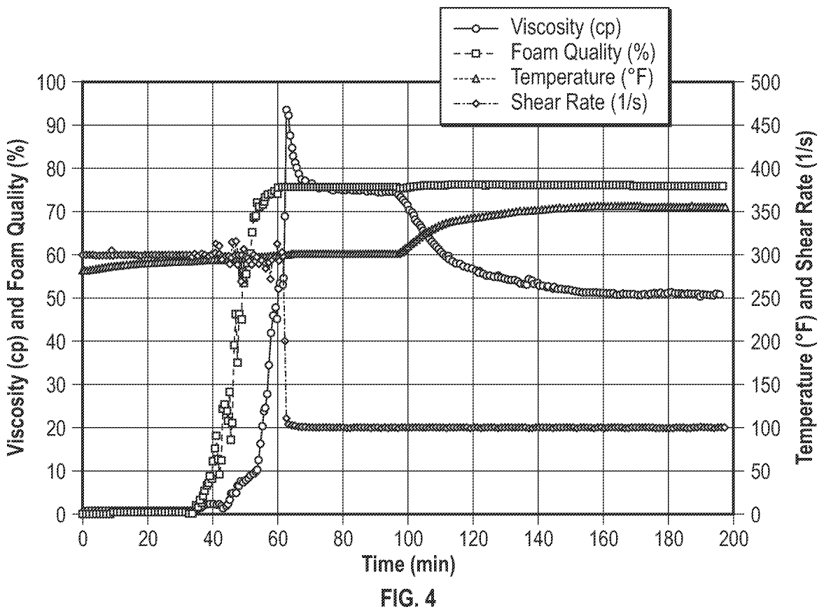

To study the synergetic effect of nanoparticles, first, a surfactant solution was prepared by mixing a 1% (vol/vol) of the Marfoam® CAB in water. Next, 2% (wt/vol) silica nanoparticles were added. The solution was placed into the circulating-loop foam rheometer. The viscosity of the foam was tested according to the method provided above. FIG. 4 shows the viscosity behavior of the foam. The viscosity of the foam stabilized with nanoparticles was found to be 75 cp at 100 1/s. After setting the bath temperature to 350° F., a decline in viscosity was observed and stabilized at 51 cp at 100 1/s. Approximately a 32% decrease in viscosity was observed, a significant improvement over the 75% decrease observed for Example 1, which was the same composition as Example 2, but did not include nanoparticles.

### Example 3

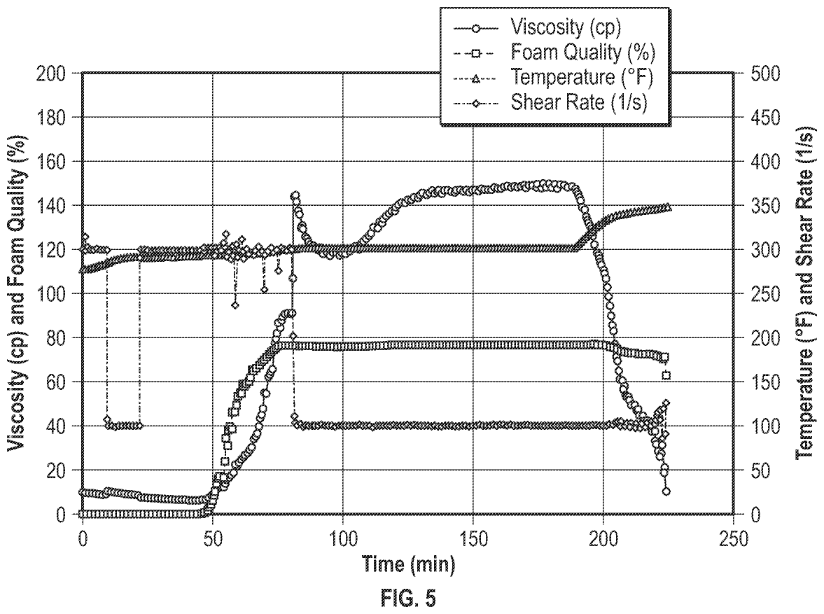

A foam was prepared as described above for a sample including 35 lb/1000 gal of acrylamide-based polymer and 1% (vol/vol) of Marfoam® CAB in water. The acrylamide-based polymer had a purity of 30% wt/vol suspension in mineral oil FIG. 5 shows the viscosity behavior of the foam. A 77% foam quality was achieved using N₂ while shearing fluid at 300 1/s and 300° F. After foam stabilization, the shear rate was dropped to 100 1/s and remained unchanged throughout the test. The stabilized viscosity of foam was measured to be 149 cp at 100 1/s. After setting the bath temperature to 350° F., a continuous decline in viscosity was observed and stabilized at 20 cp at 100 1/s. Approximately an 86% decrease in viscosity was observed.

### Example 4

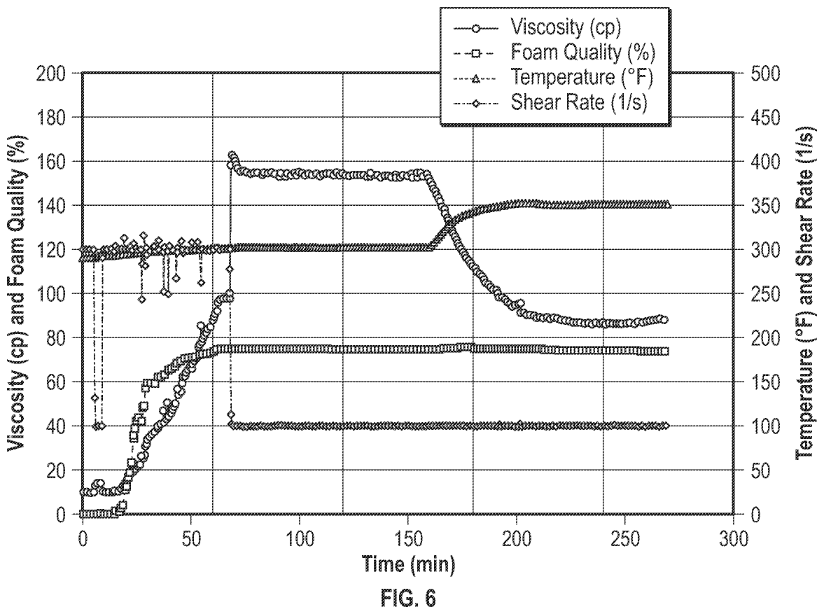

To study the synergetic effect of nanoparticles, 2% (wt/vol) silica nanoparticles were mixed with 1% (vol/vol) Marfoam® CAB and 35 lb/1000 gal of acrylamide-based polymer in water, and rheological tests were performed as described above. FIG. 6 shows the viscosity behavior of the foam. The viscosity of foam was stabilized at 154 cp at 100 1/s. After setting the bath temperature to 350° F., a decline in viscosity was observed and stabilized to 86 cp at 100 1/s. Approximately a 44% decrease in viscosity was observed, which is a significant improvement over the 86% decrease observed in the sample without nanoparticles (i.e., Example 3). As shown, nanoparticles improve the thermal stability of both foamed water and foamed linear gel.

Embodiments of the present disclosure may provide at least one of the following advantages. Foamed fracturing fluids have several advantages over conventional stimulation fluids. In particular, they are suitable for stimulating depleted reservoirs and water-sensitive formations, and they provide a shortened flow back period. Moreover, freshwater consumption is significantly reduced due to the addition of gas, for example, nitrogen or carbon dioxide. Foamed fluids can be applicable in drilling, hydraulic fracturing, acidizing, artificial lifting, removing condensate banking, diverting fluids, enhanced oil recovery, steam-foams for heavy oil and bitumen recovery, etc. In fracturing applications, foamed fracturing fluid offers distinct advantages such as excellent proppant transport, solid free fluid loss control, minimum fluid retention due to low-water content of foam, compatibility with reservoir fluids, low hydrostatic pressure to returned fluids giving faster cleanup and gas in foam helps in returning liquids to the wellbore. In acid fracturing applications, foamed acid offers additional benefits such as retardation, deeper conductivity generation, reduced water consumption, and improved acid diversion.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Ranges may be expressed as from about one particular value to about another particular value, inclusive. When such a range is expressed, it is to be understood that another embodiment is from one particular value to the other particular value, along with all particular values and combinations thereof within the range.

While the disclosure includes a limited number of embodiments, those skilled in the art, having the benefit of this disclosure, will appreciate that other embodiments may be devised which do not depart from the scope of the present disclosure. Accordingly, the scope should be limited only by the attached claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

1. A method of stimulating a hydrocarbon-bearing formation, the method comprising:
generating a foamed fracturing fluid having a foam quality of at least 20%, wherein the foamed fracturing fluid comprises:
a zwitterionic surfactant having a structure comprising a quaternary ammonium cation and a carboxylate group;
a colloidal nanosilica wherein a surface of the colloidal nanosilica includes functional groups selected from the group consisting of silane, carboxylate, amine, phosphonate, polyethylene glycol, and octadecyl; and
a gas; and
introducing the foamed fracturing fluid into the hydrocarbon-bearing formation under a pressure greater than a fracturing pressure of the hydrocarbon-bearing formation to generate fractures in the hydrocarbon-bearing formation.

2. The method of claim 1, wherein generating the foamed fracturing fluid comprises:
preparing an aqueous-based fluid comprising an aqueous fluid and the zwitterionic surfactant;
adding the colloidal nanosilica to the aqueous-based fluid; and
introducing a gas into the aqueous-based fluid comprising the zwitterionic surfactant and the colloidal nanosilica under shear mixing.

3. The method of claim 1, wherein the zwitterionic surfactant has a chemical structure represented by Formula (I): 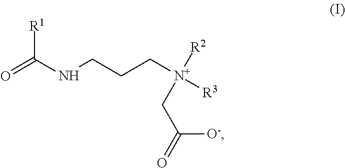
where R¹, R², and R³ are each, independently, a hydrogen, or a substituted hydrocarbon group.

4. The method of claim 1, wherein the zwitterionic surfactant is cocamidopropyl betaine having a chemical structure represented by Formula (II):

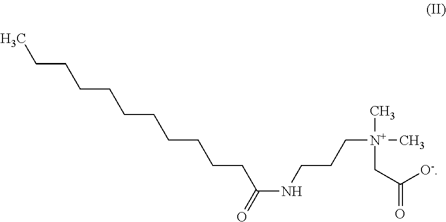

5. (canceled)

6. The method of claim 1, wherein the foamed fracturing fluid comprises from 0.1 to 20% vol/vol of the zwitterionic surfactant.

7. The method of claim 1, wherein the foamed fracturing fluid comprises from 0.1 to 40% wt/vol of the colloidal nanosilica.

8. The method of claim 1, wherein the foamed fracturing fluid further comprises at least one polymer selected from the group consisting of guar, derivatized guar, polyacrylamide, and combinations thereof.

9. The method of claim 1, wherein the foamed fracturing fluid further comprises a proppant.

10. The method of claim 1, wherein the foamed fracturing fluid further comprises an acid.

11. A method of stimulating a hydrocarbon-bearing formation, the method comprising:
introducing a foaming composition into the hydrocarbon-bearing formation under a pressure greater than a fracturing pressure of the formation to generate fractures in the hydrocarbon-bearing formation, wherein the foaming composition comprises:
a zwitterionic surfactant having a structure comprising a quaternary ammonium cation and a carboxylate group; and
a colloidal nanosilica wherein a surface of the colloidal nanosilica includes functional groups selected from the group consisting of silane, carboxylate, amine, phosphonate, polyethylene glycol, and octadecyl; and
generating a foamed fracturing fluid from the foaming composition inside the hydrocarbon-bearing formation by injecting a gas into the foaming composition in the hydrocarbon-bearing formation, wherein, the foamed fracturing fluid has a foam quality of at least 20%.

12. The method of claim 11, wherein the zwitterionic surfactant has a chemical structure represented by Formula (I): 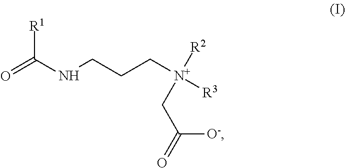
where R¹, R², and R³ are each, independently, a hydrogen, or a substituted hydrocarbon group.

13. The method of claim 11, wherein the zwitterionic surfactant is cocamidopropyl betaine having a chemical structure represented by Formula (II):

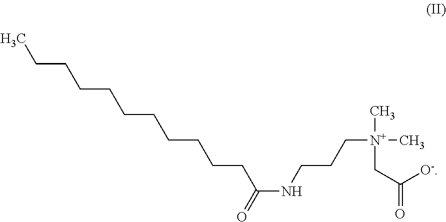

14. (canceled)

15. The method of claim 11, wherein the foamed fracturing fluid comprises from 0.1 to 20% vol/vol of the zwitterionic surfactant.

16. The method of claim 11, wherein the foamed fracturing fluid comprises from 0.1 to 40% wt/vol of the colloidal nanosilica.

17. The method of claim 11, wherein the foamed fracturing fluid further comprises at least one polymer selected from the group consisting of guar, derivatized guar, polyacrylamide, and combinations thereof.

18. The method of claim 11, wherein the foamed fracturing fluid further comprises a proppant.

19. The method of claim 11, wherein the foamed fracturing fluid further comprises an acid.
